(19) United States
(12) Patent Application Publication
(10) Pub. No.: US 2017/0213238 A1
(43) Pub. Date: Jul. 27, 2017

(54) EVALUATING PERFORMANCE OF CONTENT ITEM PRESENTATION BY MODIFYING PARAMETERS DETERMINING WHETHER TO PRESENT CONTENT ITEM TO USERS OF AN ONLINE SYSTEM

(71) Applicant: Facebook, Inc., Menlo Park, CA (US)

(72) Inventors: Anand Sumatilal Bhalgat, Mountain View, CA (US); Harsh Doshi, San Francisco, CA (US)

(21) Appl. No.: 15/006,897

(22) Filed: Jan. 26, 2016

(51) Int. Cl. G06Q 30/02

(52) U.S. Cl. CPC G06Q 30/0244; G06Q 30/0275

(57) ABSTRACT

An online system receives a set of parameters for an advertising campaign and modifies one or more of the parameters to determine how the modified parameters affect presentation of advertisements from the advertising campaign. For example, the online system increases bid amounts or a budget for the advertising campaign for a number of impression opportunities for advertisements form the advertising system. The online system subsidizes the increase so a user providing the advertisement request is not charged extra for the increased bid amounts or budget. To offset potential benefits to the advertising campaign from the modified parameters, the online system withholds the advertising campaign from being considered for a certain number of impression opportunities for which the advertising campaign would otherwise be eligible.

### BACKGROUND

This disclosure relates to presentation of content via an online system, and more specifically to evaluating different parameters for presenting content via the online system.

Online systems presenting content to users, such as such as online systems, search engines, news aggregators, Internet shopping services, and content delivery services, allow content to be presented to large numbers of users. Hence, many online systems allow users to easily communicate content to other users of the online systems. Accordingly, online systems provide an ideal venue for presenting content identifying products or services provided by a user of an online system to increase awareness of the products or services by other users of the online system.

Additionally, many online systems commonly allow users (e.g., businesses) to sponsor presentation of content on an online system to gain public attention for a user's products or services or to persuade other users to take an action regarding the user's products or services. Content for which the online system receives compensation in exchange for presenting to users is referred to as “sponsored content.” Many online systems receive compensation from a user for presenting online system users with certain types of sponsored content provided by the user. Frequently, online systems charge a user for each presentation of sponsored content to an online system user or for each interaction with sponsored content by an online system user. For example, an online system receives compensation from an entity each time a content item provided by the user is displayed to another user on the online system or each time another user is presented with a content item on the online system and interacts with the content item (e.g., selects a link included in the content item), or each time another user performs another action after being presented with the content item (e.g., visits a physical location associated with the user who provided the content item). Alternatively, some online systems receive a fixed amount of compensation from users for presenting sponsored content from the user for a certain amount of time.

When selecting sponsored content for presentation to users, many online systems use amounts of compensation associated with various sponsored content items by users. An amount of compensation associated with a sponsored content item specifies a maximum amount of compensation a user is willing to provide an online system in exchange for presenting the sponsored content item to other users. For example, when an online system identifies an opportunity to present sponsored content to a user, the online system ranks various sponsored content items by their associated amounts of compensation and selects a sponsored content item associated with threshold positions in the ranking (e.g., a sponsored content item having a highest position in the ranking).

However, context in which an online system presents sponsored content to a user may affect the value of the sponsored content to a user providing the sponsored content to the online system, which affects an amount of compensation the user providing the sponsored content is willing to provide the online system for presenting the sponsored content. For example, a user is likely to provide the online system with increased compensation if sponsored content from the user is presented to another user likely to view or interact with the sponsored content (e.g., access the sponsored content, purchase a product or service associated with the sponsored content, download an application associated with the sponsored content, etc.). To account for variations in context for presenting sponsored content, an online system may allow a user to specify various parameters (e.g., budget, a number of times sponsored content is presented to users, a duration during which sponsored content is presented) for presenting sponsored content, and the online system determines amounts of compensation received from presenting the sponsored content based on the parameters. Hence, users may allow the online system to account for different contexts in which sponsored content is presented to determine amounts of compensation the users provide the online system for presenting the sponsored content

When an online system determines amounts of compensation users is willing to provide for sponsored content items based on parameters specified by the users, the parameters specified by the users affect the likelihood that sponsored content provided by different users is presented by the online system. Some online systems maintain various statistics describing presentation of sponsored content that users may account for when providing parameters for presenting sponsored content to the online system. For example, a user may modify one or more parameters to increase an amount of compensation the user is willing to provide the online system for presenting sponsored content to a particular user who previously interacted with similar sponsored content based on information identifying amounts of compensation previously provided to the online system by users associated with sponsored content previously presented to the user. However, statistics maintained for certain parameters may be insufficient for a user to assess effects from modifying the certain parameters, which may prevent user modification of certain parameters for presenting sponsored content. Limited modification of parameters for presenting sponsored content by users may reduce presentation of sponsored content from those users, which may reduce revenue to an online system from the users

### SUMMARY

An online system receives a set of delivery parameters (e.g., bid, budget, duration, etc.) for an advertising (“ad”) campaign including one or more advertisement requests (“ad requests”) that each include advertisements for presentation to users of the online system. The online system modifies one or more of the parameters for the ad campaign when different opportunities to present an advertisement from the ad campaign (also referred to as “impression opportunities”) are identified and determines how modifying one or more of the parameters affects performance of the ad campaign. For example, the online system determines how modifications to one or more parameters of the ad campaign affect a conversion rate of the ad campaign. To modify one or more parameters of the ad campaign, in various embodiments, the online system determines a set of impression opportunities for the ad campaign and divides the set of impression opportunities into a control set, a test set, and an ineligible set. The online system modifies one or more parameters of the ad campaign for impression opportunities in the test set. For example, the online system increases bid amounts or a budget for the ad campaign for impression opportunities in the test set and subsidizes the increase to the bid amounts or to the budget, allowing the online system to determine performance of the ad campaign with higher bid amounts or with a higher budget. The online system does not modify parameters for the ad campaign for impression opportunities in the control set, allowing evaluation of the ad campaign's performance with the modified parameters relative to the ad campaign's performance with the unmodified parameters. In the preceding example, the online system does not increase bid amounts to or the budget for the ad campaign for impression opportunities in the control group.

Subsidizing increases the ad campaign's bid amounts or budget for impression opportunities in the test set by the online system may significantly increase a likelihood of advertisements from the ad campaign being presented by impressions in the test set, and may increase bid amounts for advertisements in the ad campaign to amounts greater than users associated with other ad campaigns are willing to provide. To offset the increased likelihood of selecting advertisements from the ad campaign with the increased bid amounts or budget for impressions in the test set and mitigate potential increases in amounts spent by users associated with various ad campaigns caused by the increased bid amounts or budget for the ad campaign, the online system withholds advertisements from the ad campaign from selection processes for impression opportunities in the ineligible set, which includes impression opportunities for which advertisements from the ad campaign would otherwise be eligible for inclusion in selection processes without the increased bid amount or budget. Withholding the ad campaign from consideration for impression opportunities in the ineligible set reduces competition to advertisements from other ad campaigns for the impression opportunities in the ineligible set, allowing selection of advertisements associated with lower bid amounts, relative to the increased bid amounts or budget for the ad campaign, for presentation via impression opportunities in the ineligible set. The online system determines a number of impression opportunities in the ineligible set so an amount of compensation the online system receives per advertisement selected for presentation via impression opportunities in the control set, which includes impression opportunities for which advertisements from the ad request are eligible for presentation without an increased bid amount or budget, equals an amount of compensation the online system receives per advertisement selected for presentation via impression opportunities in a combination of the test set and the ineligible set.

Hence, a user associated with the ad campaign does not provide the online system with additional compensation for exploring performance of the ad campaign with increased bid amounts or budget and the overall amounts of compensation to the online system for presenting advertisements to users does not increase because of the increased bid amounts or budget for the ad campaign. Additionally, the ad campaign does not receive an unfair increase in presentation to users because of its increased bid amounts or budget. The online system may determine performance of the ad campaign for different increases to bid amounts or the budget and maintain information associating ad campaign performance with different increased bid amounts or budget.

### BRIEF DESCRIPTION OF THE DRAWINGS

FIG. 1 is a block diagram illustrating the operation of ad delivery in an advertisement system, according to one embodiment.

FIG. 2 is a high level block diagram of a system environment suitable for performing ad delivery, according to one embodiment.

FIG. 3 is a flowchart illustrating a process for evaluating performance of an advertising campaign when parameters of the advertising campaign are modified by an online system, according to one embodiment.

FIG. 4 is a high level diagram of an ad impression opportunity space for an ad campaign, according to one embodiment.

FIG. 5 is a flowchart illustrating a process for generating a model describing performance of an advertising campaign when one or more parameters of the advertising campaign are modified, according to one embodiment.

FIG. 6 is a graph showing a relationship between bid amounts and impression value, according to one embodiment.

The figures depict various embodiments for purposes of illustration only. One skilled in the art will readily recognize from the following discussion that alternative embodiments of the structures and methods illustrated herein may be employed without departing from the principles of described herein.

### DETAILED DESCRIPTION

### Overview

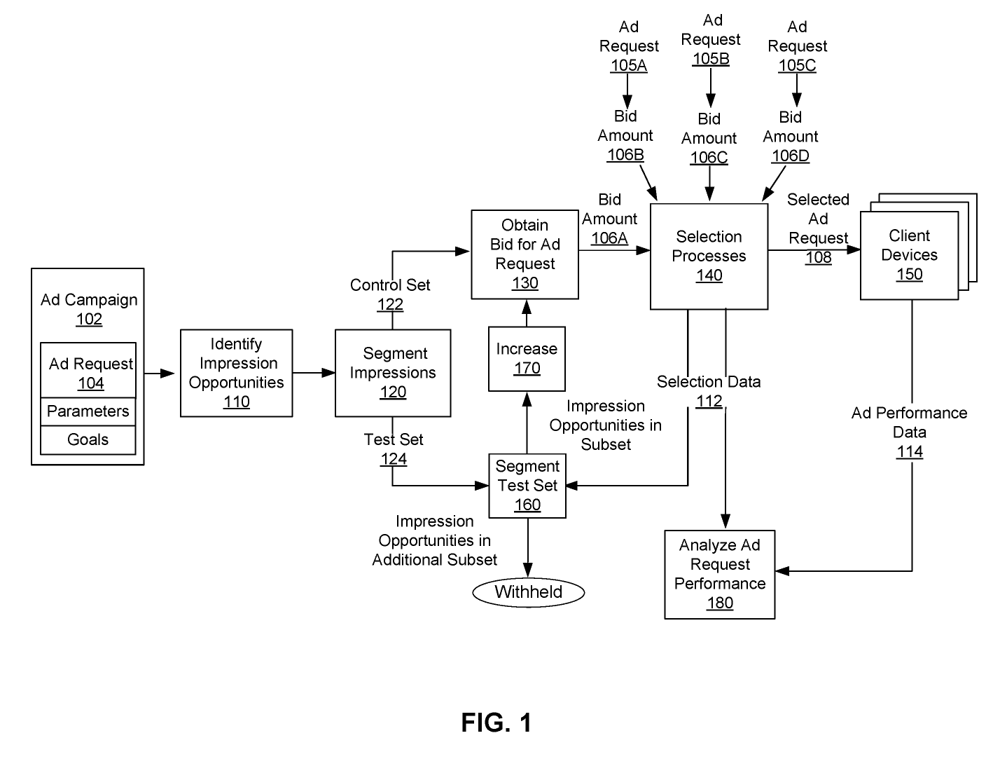

FIG. 1 is a process flow diagram of one embodiment of advertisement (“ad”) delivery by an online system. An online system, such as a social networking system, receives ad campaign 102 including advertisement request (“ad request”) 104 and other ad requests for presentation to users of the online system when an opportunity to present one or more advertisements occurs (i.e., when the online system identifies an “impression opportunity” for one or more ads). Ad campaign 102 may include multiple ad requests each including different advertisements for presentation to users, different targeting criteria identifying characteristics of users eligible to be presented with advertisements in the ad requests, and other parameters; however, for simplicity of explanation, FIG. 1 describes ad campaign 102 as including ad request 104. In various embodiments, ad campaign 102 may be received from a third party system or may be maintained by the online system.

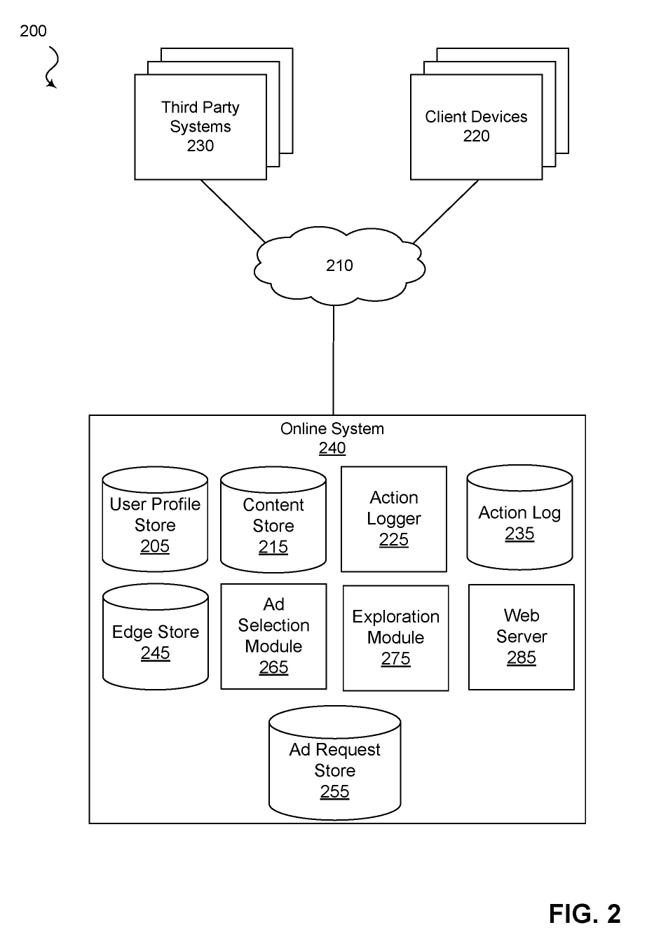

Ad request 104 includes content for presentation to users (also referred to herein as an “advertisement”) such as one or more images, video, text, or other media. Additionally, ad request 104 includes one or more parameters, such as a bid amount specifying an amount of compensation the online system receives in exchange for presenting the advertisement in ad request 104, a budget specifying a total amount available for presentation of the advertisement in ad request 104 to users of the online system, a time period during which the advertisement in ad request 104 is eligible for presentation to users, or other information. In various embodiments, one or more parameters are associated with ad campaign 102, so the parameters are included in multiple ad requests in ad campaign 102. One or more objectives may also be associated with ad request 104 or with ad campaign 102. An objective describes one or more goals for actions associated with ad campaign 102, as further described below in conjunction with FIG. 2. Example goals include: a number of impressions of ad requests included in ad campaign 102 desired by a user associated with ad campaign 102 or a number of a particular type of interaction performed by users presented with ad requests in ad campaign 102 desired by the user associated with ad campaign 102.

As changes to one or more parameters associated with ad campaign 102 affect performance of ad campaign 102, the online system may modify one or more parameters or combinations of parameters to obtain information describing performance of ad campaign 102 with different parameters. Information describing performance of ad campaign 102 with different parameters may be provided to a user associated with ad campaign 102 to identify potential changes to parameters, such as changes to bid amounts of one or more ad requests in ad campaign 102 or to a budget for ad campaign 102. To evaluate performance of ad campaign 102 with different parameters, the online system identifies 110 a set of impression opportunities for advertisements from ad campaign 102 based on parameters of the ad campaign 102. Each impression opportunity corresponds to an opportunity to present the advertisement from ad request 104 to a user of the online system. In various embodiments, the online system identifies 110 impression opportunities based on a budget for ad campaign 102 and a number of impressions of advertisements from ad campaign 102 desired by the user associated with ad campaign 102, as described further below.

The online system segments 120 the identified set of impression opportunities for ad campaign 102 into control set 122 and test set 124. Ad request 104 is evaluated for presentation via impression opportunities in control set 122 using the parameters associated with ad campaign 102, while ad request 104 is evaluated for presentation via impression opportunities in test set 124 using different delivery parameters than those associated with ad campaign 102. In one example, the online system segments 120 the identified set of impression opportunities by selecting a specific percentage (e.g., 5-10%) of impression opportunities in the identified set of impression opportunities as test set 124 and allocating the remaining percentage (e.g., 90-95%) of impression opportunities in the identified set of impression opportunities as control set 122. Accordingly, for each impression opportunity in control set 122, the online system obtains 130 bid amount 106A for ad request 104 from parameters associated with ad campaign 102. Bid amount 106A specifies a maximum amount of compensation the user associated with ad campaign 102 will provide to the online system for presenting the advertisement from ad request 104 to a user.

However, for an impression opportunity in test set 124, the online system determines whether to increase bid amount 106A of ad request 104 relative to the bid amount determined from parameters (e.g., budget, desired number of impressions) in ad campaign 102. In one embodiment, the online system increases 170 bid amount 106A of ad request 104 relative to a bid amount determined from parameters in ad campaign 102 for a subset of impression opportunities in test set 124. When the online system increases bid amount 106A of ad request 104, the online system subsidizes the increase so the user associated with ad campaign 102 does not provide the online system with compensation greater than the bid amount determined from parameters in ad campaign 102. Increasing bid amount 106A may increase a likelihood of the advertisement from ad request 104 being presented to a user via an impression opportunity, but may also increase an amount of compensation provided to the online system for each presentation of an advertisement (i.e., an average price of an impression or a “per-ad spend” by users associated with ad requests). This increase may result in amounts of compensation beyond those that users associated with some ad requests are willing to provide to the online system. To offset the advantage to the user associated with ad campaign 102 from increasing bid amount 106A, and to mitigate potential increases in the average price of an impression, the online system also withholds ad request 104 from evaluation for presentation via an additional subset of impression opportunities in test set 124 in which ad request 104 would otherwise be eligible for presentation. Withholding ad request 104 from presentation via impression opportunities in the additional subset of test set 124 reduces competition to users associated with other ad campaigns for presentation of advertisements via impression opportunities in the additional subset of test set 124. This reduction in competition for impression opportunities in the additional subset of test set 124 mitigates increases in price per impression from increasing bid amount 106A for impression opportunities in the subset of test set 124. The online system determines a number of impression opportunities in the additional subset so an average amount received by the online system for presenting advertisements via impression opportunities in control set 122 equals (or is within a threshold amount of) a ratio of an amount received by the online system for presenting advertisements via impression opportunities in the subset of test set 124 and via impression opportunities in the additional subset of test set 124 to a number of impression opportunities in test set 124.

Accordingly, the online system segments 160 test set 124 into the subset and the additional subset based on selection data 112 from one or more selection processes 140 that selected advertisements for presentation via impression opportunities. The online system may modify the number of impression opportunities in the additional subset of test set 124 as various advertisements are selected for presentation via impression opportunities, allowing the online system to modify a number of impression opportunities in test set 124 from which ad request 104 from ad campaign 102 is withheld from being evaluated for presentation. For example, selection data 112 identifies bid amounts of ad requests from which advertisements were selected for presentation as well as amounts charged to entities associated with ad requests from which advertisements were selected for presentation. In one embodiment, the online system 140 dynamically determines and updates average amounts charged for advertisements included in ad requests selected for presentation via impression opportunities from control set 122 and via impression opportunities from test set 124 as the one or more selection processes 140 select advertisements for presentation via impression opportunities and modifies the number of impression opportunities in the additional subset of the test set 124 accordingly. This allows the online system to dynamically modify a number of impression opportunities from which ad request 104 from ad campaign 102 is excluded from evaluation for presentation. Alternatively, the online system selects advertisements for presentation via all impression opportunities in control set 122 then selects advertisements for presentation via impression opportunities in the subset of test set 124 via one or more selection processes 140. In this embodiment, the average amount of compensation received by the online system for presenting advertisements via impression opportunities in control set 122 is determined prior to selecting of advertisements for presentation via impression opportunities included in test set 124, so a number of impression opportunities in the additional subset of test set 124 is based on a desired total subsidy (i.e., sum of individual bid amount subsidies) to be provided to the subset of test set 124.

Accordingly, for impression opportunities in the subset of test set 124, the online system increases 170 bid amount 106A of ad request 104 from ad campaign 102, while withholding ad request 104 from ad campaign 102 from being included in one or more selection processes 104 selecting advertisements for presentation via impression opportunities in the additional subset of test set 124. In one example, the online system increases 170 bid amount 106A by modifying one or more parameters of ad campaign 102 or of ad request 104 (e.g., increasing a pacing parameter, increasing a budget, increasing a duration, etc.). Alternatively, the online system initially obtains 130 bid amount 106A for ad request 104 in ad campaign 102 and increases 170 the obtained bid amount via a weight, addition of an adjustment amount, or other modification. The online system includes ad request 104, along with the increased bid amount 106A, in one or more selection processes 140 for an impression opportunity in the subset of test set 124 along with other ad requests 105A, 105B, 105C and their associated bid amounts 106B, 106C, 106D. Similarly, the online system includes ad request 104 from ad campaign 102 along with bid amount 106A determined from parameters in ad campaign 102 in one or more selection processes 140 for impression opportunities in control set 122 along with other ad requests 105A, 105B, 105C and their associated bid amounts 106B, 106C, 106D.

For an impression opportunity, one or more selection processes 140 select an advertisement from various ad requests 104, 105A, 105B, 105C for presentation to a user via one or more client devices 150. If an impression opportunity is in control set 122, one or more selection processes 140 use bid amount 106A determined from parameters in ad request 102 when selecting an advertisement from ad request 104 and ad requests 105A, 105B, 105C. If an impression opportunity is in the subset of test set 124, one or more selection processes 140 use increased bid amount 106A when selecting an advertisement from ad request 104 and ad requests 105A, 105B, 105C. However, if an impression opportunity is in the additional subset of test set 124, ad request 104 is not included one or more selection processes 140, which select an advertisement from ad requests 105A, 105B, 105C. One or more selection processes 140 communicate selected advertisement 108 from an ad request to client device 150 for display to a user. In various embodiments, a selection process 140 selects an ad request having a maximum bid amount. However, in some embodiments, a selection process 140 accounts for other criteria when selecting an ad request. Example criteria that may be used by selection process 140 include: as a context in which an advertisement is to be presented by an impression opportunity, a user associated with the impression opportunity, a type of client device 150 on which the advertisement from the ad request is to be presented, and any other suitable criteria.

When one or more selection processes 140 select an advertisement, the online system modifies segmentation 160 of test set 124 the subset and the additional subset based on selection data 112 describing the selection of selected ad request 108. Selection data 112 for an impression opportunity may identify a bid amount included in selected ad request 108, as well as a price charged by the online system for presentation of selected ad request 108, as the bid amount of selected ad request 108 may differ from the amount the online system charges to a user associated with selected ad request 108. As described above, the online system may modify segmentation of test set 124 into the subset and the additional subset based on ad requests selected for various impression opportunities.

The online system receives information from client devices 150 presenting advertisements from ad requests and determines performance 114 data for the ad requests accordingly. For example, the online system determines a conversion rate for ad request 104 as a ratio of a number of one or more specific interactions with an advertisement from ad request 104 to a number of impressions of the advertisement from ad request 104 based on information received from client devices 150. In one embodiment, the online system analyzes 180 selection data 112 and performance data 114 from client devices 150 to determine the performance of the advertisement from ad request 104 when bid amount 106A of ad request 104 was increased and when bid amount 106A of ad request 104 was not increased. For example, the online system determines a relationship between performance of ad request 104 and increases to bid amount 106A of ad request 104 relative to bid amount 106A of ad request 104 from parameters in ad campaign 102. In some embodiments, the online system determines the relationship between increasing bid amount 106A of ad request 104 and performance of ad request 104 as a model or a function, which may be provided to a user associated with ad campaign 102. The user associated with ad campaign 102 may modify one or more parameters of ad campaign 102 based on the model or function to improve performance of ad campaign 102.

### System Architecture

FIG. 2 is a block diagram of system environment 200 for online system 240. System environment 200 shown by FIG. 2 comprises one or more client devices 150, network 210, one or more third-party systems 230, and online system 240. In alternative configurations, different and/or additional components may be included in the system environment 200. Online system 240 may be a social networking system, a content sharing system, or any other system providing content to its users.

Client devices 150 are one or more computing devices capable of receiving user input as well as transmitting and/or receiving data via network 210. In one embodiment, client device 150 is a conventional computer system, such as a desktop or a laptop computer. Alternatively, client device 150 may be a device having computer functionality, such as a personal digital assistant (PDA), a mobile telephone, a smartphone, a smartwatch, or another suitable device. Client device 150 is configured to communicate via network 210. In one embodiment, client device 150 executes an application allowing a user of client device 150 to interact with online system 240. For example, client device 150 executes a browser application to enable interaction between client device 150 and online system 240 via network 210. In another embodiment, client device 150 interacts with online system 240 through an application programming interface (API) running on a native operating system of client device 150, such as IOS® or ANDROID™.

Client devices 150 are configured to communicate via network 210, which may comprise any combination of local area and/or wide area networks, using both wired and/or wireless communication systems. In one embodiment, network 210 uses standard communications technologies and/or protocols. For example, network 210 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via network 210 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over network 210 may be represented using any suitable format, such as hypertext markup language (HTML) or extensible markup language (XML). In some embodiments, all or some of the communication links of network 210 may be encrypted using any suitable technique or techniques.

One or more third party systems 230 may be coupled to network 210 for communicating with online system 240. In one embodiment, third party system 230 is an application provider communicating information describing applications for execution by client device 150 or communicating data to client devices 150 for use by an application executing on the client device. In other embodiments, third party system 230 provides content or other information for presentation via client device 150. Third party system 230 may also communicate information to online system 240, such as advertisements, content, or information about an application provided by third party system 230.

Online system 240, shown in FIG. 2, includes user profile store 205, content store 215, action logger 225, action log 235, edge store 245, advertisement request (“ad request”) store 255, exploration module 265, ad selection module 265, and web server 285. In other embodiments, online system 240 may include additional, fewer, or different components for various applications. Conventional components such as network interfaces, security functions, load balancers, failover servers, management and network operations consoles, and the like are not shown so as to not obscure the details of the system architecture.

Each user of online system 240 is associated with a user profile, which is stored in user profile store 205. A user profile includes declarative information about the user that was explicitly shared by the user and may also include profile information inferred by online system 240. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in user profile store 205 may also maintain references to actions by the corresponding user performed on content items in content store 215 and stored in action log 235.

While user profiles in user profile store 205 are frequently associated with individuals, allowing individuals to interact with each other via online system 240, user profiles may also be stored for entities such as businesses or organizations. This allows an entity to establish a presence on online system 240 for connecting and exchanging content with other online system users. The entity may post information about itself, about its products or provide other information to users of the online system 240 using a brand page associated with the entity's user profile. Other users of the online system 240 may connect to the brand page to receive information posted to the brand page or to receive information from the brand page. A user profile associated with the brand page may include information about the entity itself, providing users with background or informational data about the entity.

Content store 215 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by content store 215, such as status updates, photos tagged by users to be associated with other objects in the online system 240, events, groups or applications. In some embodiments, objects are received from third-party applications or third-party applications separate from the online system 240. In one embodiment, objects in content store 215 represent single pieces of content, or content “items.” Hence, online system users are encouraged to communicate with each other by posting text and content items of various types of media to online system 240 through various communication channels. This increases the amount of interaction of users with each other and increases the frequency with which users interact within online system 240.

Action logger 225 receives communications about user actions internal to and/or external to online system 240, populating action log 235 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in action log 235.

Action log 235 may be used by online system 240 to track user actions on online system 240, as well as actions on third party systems 230 that communicate information to online system 240. Users may interact with various objects on online system 240, and information describing these interactions is stored in action log 235. Examples of interactions with objects include: commenting on posts, sharing links, checking-in to physical locations via client device 150, accessing content items, and any other suitable interactions. Additional examples of interactions with objects on online system 240 that are included in action log 235 include: commenting on a photo album, communicating with a user, establishing a connection with an object, joining an event, joining a group, creating an event, authorizing an application, using an application, expressing a preference for an object (“liking” the object), and engaging in a transaction. Additionally, action log 235 may record a user's interactions with advertisements on online system 240 as well as with other applications operating on online system 240. In some embodiments, data from action log 235 is used to infer interests or preferences of a user, augmenting the interests included in the user's user profile and allowing a more complete understanding of user preferences.

Action log 235 may also store user actions taken on third party system 230, such as an external website, and communicated to online system 240. For example, an e-commerce website may recognize a user of online system 240 through a social plug-in enabling the e-commerce website to identify the user of online system 240. Because users of online system 240 are uniquely identifiable, e-commerce websites, such as in the preceding example, may communicate information about a user's actions outside of online system 240 to online system 240 for association with the user. Hence, action log 235 may record information about actions users perform on third party system 230, including webpage viewing histories, advertisements that were engaged, purchases made, and other patterns from shopping and buying. Additionally, actions a user performs via an application associated with third party system 230 and executing on client device 150 may be communicated to action logger 225 by the application for recordation and association with the user in action log 235.

In one embodiment, edge store 245 stores information describing connections between users and other objects on online system 240 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in online system 240, such as expressing interest in a page on online system 240, sharing a link with other users of online system 240, and commenting on posts made by other users of online system 240.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or a number of comments posted by a user about an object, as well as types of comments posted by a user about an object. The features may also represent information describing a particular object or user. For example, a feature may represent the level of interest that a user has in a particular topic, the rate at which the user logs into online system 240, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

Edge store 245 also stores information about edges, such as affinity scores for objects, interests, and other users. Affinity scores, or “affinities,” may be computed by the online system 240 over time to approximate a user's interest in an object or in another user in online system 240 based on the actions performed by the user. A user's affinity may be computed by online system 240 over time to approximate the user's interest in an object, in a topic, or in another user in online system 240 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in edge store 245, in one embodiment. Alternatively, each interaction between a user and a specific object is stored as a separate edge. In some embodiments, connections between users may be stored in user profile store 205, or user profile store 205 may access edge store 245 to determine connections between users.

Advertisement request (“ad request”) store 255 stores information describing advertisement (“ad”) campaigns received from one or more advertisers. Each advertising campaign includes one or more ad requests. An ad request includes advertisement content (also referred to herein as an “advertisement”), which is text, image, audio, video, or any other suitable data presented to a user. In various embodiments, the advertisement content is associated with a network address specifying a landing page, or other destination, to which a user is directed when the advertisement is accessed. In addition to including one or more ad requests, an advertising campaign is associated with various parameters describing presentation of ad requests in the advertising campaign. Example parameters include: a budget, one or more objectives for the advertising campaign, a duration, and a target average price. However, other suitable parameters may be associated with an advertising campaign in various embodiments.

A target average price specifies an amount of compensation a user associated with an advertising campaign (e.g., an advertiser) desires to pay the online system 240 per action associated with advertisements from ad requests in the advertising campaign. For example, the target average price specifies an average amount of compensation from the user associated with the advertising campaign to online system 240 for each impression of an advertisement from an ad request in the advertising campaign to online system users 240. As another example, the target average price specifies an average amount of compensation from the user associated with the advertising campaign to online system 240 for each of one or more specific interactions with advertisements from the advertising campaign by online system users (i.e., for each conversion event associated with advertisements from the advertising campaign).

The budget represents a total amount of revenue a user associated with an advertising campaign has allocated for compensating online system 240 for presenting advertisements in the advertising campaign. An amount is deducted from the budget each time an advertisement from the advertising campaign is presented to an online system user or each time a user presented with an advertisement from the advertising campaign performs one or more specific interactions with the presented advertisement from the advertising campaign. When the budget is exhausted, online system 240 ceases presentation of advertisements from the advertising campaign associated with the budget.

An objective associated with an advertising campaign describes one or more goals for actions associated with the advertising campaign. For example, an objective specifies a total number of impressions of advertisements in the advertising campaign to online system users (an “impression objective”), specifies a total number of unique online system users to be presented with at least one advertisement from the advertising campaign (a “reach objective”), a number of times an advertisement from the advertising campaign is presented to an online system user (a “frequency objective”), or any other suitable criteria. Any suitable objective may be associated with the advertising campaign in various embodiments. Additionally, the duration associated with the advertising campaign specifies a time interval during which advertisements from the advertising campaign are presented to online system users. For example, if the duration of an advertising campaign is 30 days, advertisements included in the advertising campaign are presented to online system users for 30 days after the advertising campaign is provided to online system 240 or until the budget is exhausted. In some embodiments, a user associated with the advertising campaign specifies a start date for the advertising campaign, so the duration is measured from the specified start date.

In some embodiments, ad requests in an advertising campaign include a bid amount along with an advertisement. The bid amount included in an ad request represents a maximum amount of compensation, such as monetary compensation, a user associated with the advertising request provides online system 240 in exchange for presentation of the advertisement included in the ad request. In some embodiments, online system 240 determines an expected value to online system 240 for presenting an advertisement to a user based on a bid amount included in an ad request that also includes the advertisement and a likelihood of the user interacting with the advertisement if it is presented to the user. For example, a bid amount included in an ad request including an advertisement specifies a maximum monetary amount that online system 240 receives from a user associated with the ad request if the advertisement is displayed to a user, or if the user performs one or more specific interactions with the advertisement, and the expected value to online system 240 from presenting the advertisement is determined by multiplying the bid amount by a probability of the user interacting with the advertisement.

Additionally, an ad request may include one or more targeting criteria specified by a user associated with the ad request. Targeting criteria included in an ad request specify one or more characteristics of users eligible to be presented with advertisement content associated with the ad request. For example, targeting criteria are used to identify users having user profile information, edges or actions satisfying at least one of the targeting criteria. Hence, targeting criteria allow an advertiser to identify users having specific characteristics, simplifying subsequent distribution of ad content to different users. Additionally, targeting criteria may be associated with an advertising campaign, allowing the targeting criteria to be included in multiple ad requests of the advertising campaign.

In one embodiment, targeting criteria may specify actions or types of connections between a user and another user or object of online system 240. Targeting criteria may also specify interactions between a user and objects performed external to online system 240, such as on third party system 230. For example, targeting criteria identifies users that have taken a particular action, such as sending a message to another user, using an application, joining a group, leaving a group, joining an event, generating an event description, purchasing or reviewing a product or service using an online marketplace, requesting information from third party system 230, or any other suitable action. Including actions in targeting criteria allows advertisers to further refine users eligible to be presented with ad content in an ad request that includes the targeting criteria. As another example, targeting criteria identifies users having a connection to another user or object or having a particular type of connection to another user or object.

Advertisement (“ad”) selection module 265 receives ad requests from various advertising campaigns and selects one or more advertisements from the ad requests for presentation to an online system user. In some embodiments, ad selection module 240 determines an expected value associated with each ad request based at least in part on the bid amounts included in the ad requests. Based at least in part on their expected values, ad selection module 265 ranks the ad requests and selects advertisements having at least a threshold position in the ranking for presentation. Alternatively, ad selection module 265 selects ad requests having at least a threshold expected value for presentation. Ad selection module 265 charges a user associated with a selected ad request an amount based at least in part on one or more bid amounts included in ad requests that were not selected; for example, a user associated with a selected ad request is charged an amount that is a specified amount greater than maximum bid amount from bid amounts of ad requests that were not selected. However, other suitable methods may be used to determine an amount charged to a user associated with a selected bid amount based on bid amounts associated with ad requests. In some embodiments, ad selection module 265 uses one or more auctions based on bid amounts included in ad requests to select one or more ad requests. Hence, in various embodiments, online system 240 charges a user associated with a selected ad request an amount less than or equal to the bid amount included in the selected ad request, so the bid amount included in the selected ad request is a maximum amount the user associated with a selected ad request compensates online system 240 if an advertisement from the selected ad request is presented or if a user interacts with the presented advertisement from the selected ad request.

In various embodiments, ad selection module 265 determines a bid amount for an ad request based on parameters of an advertising campaign including the ad request rather than retrieving a bid amount included in the ad request. For example, ad selection module 265 determines a budget for an advertising campaign including the ad request and an impression objective for the advertising campaign including the ad request and determines a bid amount for the ad request based on the budget, the impression objective, the amount of the budget that has been used, and the amount of the impression objective that has been completed. Ad selection module then uses the determined bid amount for the ad request when determining whether to select the ad request. Determining a bid amount for an ad request based on parameters associated with the ad request or associated with an advertising campaign including the ad request is further described in U.S. patent application Ser. No. 13/294,094, filed on Nov. 10, 2011, which is incorporated by reference in its entirety.

Exploration module 275 modifies one or more parameters of an advertising campaign in ad request store 255 and captures data describing performance of the advertising campaign with the modified parameters. Parameters of the advertising campaign modified by exploration module 275 may be specified by a user who provided the advertising campaign to online system 240 or may be specified by an administrator or other online system user authorized by the user providing the advertising campaign to online system 240 to modify parameters of the advertising campaign. In various embodiments, the user providing the advertising campaign to online system 240 or other user authorized by the user providing the advertising campaign to online system 240 to modify parameters of the advertising campaign specifies a number of impression opportunities for advertisements from the advertising campaign in which modified parameters are used or specifies a percentage of impression opportunities for advertisements from the advertising campaign in which modified parameters are used. For example, ad selection module 265 determines a set of impression opportunities for an advertising campaign and exploration module 275 divides the set into a control set and a test set. Exploration module 275 increases the bid amounts or budget for ad requests in the advertising campaign for impression opportunities in the test set to evaluate performance of the advertising campaign with the increased bid amounts or budget relative to performance of the advertising campaign with unmodified bid amounts or an unmodified budget for impression opportunities in the control set. When evaluating increased bid amounts or an increased budget for the advertising campaign, online system 240 subsidizes the increase, so the user providing the advertising campaign does not pay more than the budget or bid amount specified for the advertising campaign.

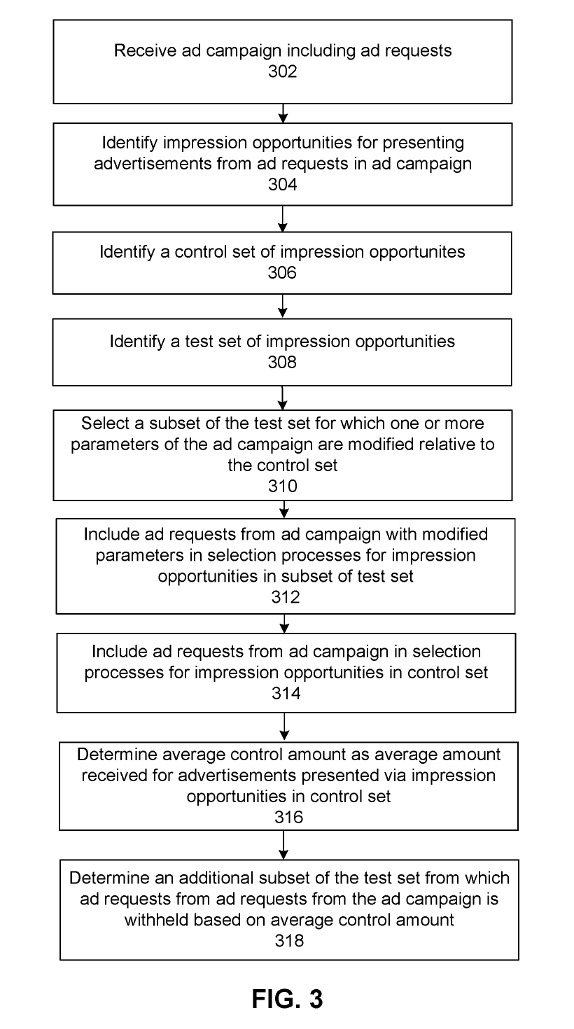

Increasing the bid amounts or budget for an advertising campaign may greatly increase likelihoods of advertisements from the advertising campaign being selected for presentation via various impression opportunities. Additionally, the increased bid amounts or increased budget may increase an average amount of compensation provided to online system 240 per impression of advertisements (i.e., a “per-ad spend”) beyond maximum amounts of compensation users associated with other advertising campaigns are willing to provide. To offset the increased likelihood of selecting ad requests from the advertising campaign when the budget or bid amounts are increased and to mitigate increased in per-ad spend, exploration module 275 withholds ad requests from the advertising campaign from inclusion in selection processes for a number of impression opportunities for which the ad requests from the advertising campaign would otherwise be eligible with the unmodified budget or bid amounts. Withholding ad requests from the advertising campaign from selection processes for the number of impression opportunities reduces competition for other advertising campaigns for the number of impressions opportunities, increasing a likelihood of ad requests with lower bid amounts being selected for the number of impression opportunities, which decreases the per-ad spend. As further described below in conjunction with FIGS. 3-6, exploration module 275 determines the number of impression opportunities for which ad requests from the advertising campaign is withheld from so that a per-ad spend in the control set of impression opportunities (i.e., the impression opportunities for which a budget or bid amounts of ad requests from the advertising campaign are not increased) equals, or is within a threshold amount of, a per-ad spend in the test set of impression opportunities (i.e., impression opportunities for which the budget or the bid amount of ad requests from the advertising campaign is increased and impression opportunities from which ad requests from the advertising campaign are withheld from selection processes).

Information describing advertisements from ad requests selected by ad selection module 265 may be maintained by the ad selection module 265. For example, ad selection module 265 identifies a selected ad request in association with a bid amount and an amount charged to a user associated with the selected ad request. Other metrics may also be associated with the selected ad request, such as a ratio of a number of one or more interactions to a number of impressions of an advertisement from the selected ad request in various embodiments. Information describing characteristics of users to whom the advertisement from the selected ad request was presented may also be associated with the selected ad request, as well as a time when the advertisement from the selected ad request was presented. Exploration module may determine a relationship between increases to a bid amount or to bid amounts of an advertising campaign based on information describing ad requests from the advertising campaign including advertisements that were presented to users. The relationship may expressed as a model or function, which may be provided to the user who provided the advertising campaign to modify one or more parameters of an ad campaign based on the model or function.

Web server 285 links online system 240 via network 210 to one or more client devices 150, as well as to one or more third party systems 230. Web server 285 serves web pages, as well as other content, such as JAVA®, FLASH®, XML and so forth. Web server 285 may receive and route messages between online system 240 and client device 150, for example, instant messages, queued messages (e.g., email), text messages, short message service (SMS) messages, or messages sent using any other suitable messaging technique. A user may send a request to web server 285 to upload information (e.g., images or videos) that is stored in content store 215. Additionally, web server 285 may provide application programming interface (API) functionality to send data directly to native client device operating systems, such as IOS®, ANDROID™, WEBOS® or BlackberryOS.

Evaluating Performance of an Advertising Campaign with One or More Modified Parameters

FIG. 3 is a flowchart illustrating one embodiment of a process for evaluating performance of an advertising campaign (“ad campaign”) when parameters of the advertising campaign are modified by online system 240. In various embodiments, the process may include different or additional steps than those described in conjunction with FIG. 3. Additionally, in some embodiments, steps of the process may be performed in different orders than the order described in conjunction with FIG. 3

Online system 240 receives 302 an ad campaign including one or more ad requests. As further described above in conjunction with FIG. 2, each ad request includes an advertisement comprising content for presentation to online system users. Additionally, the ad campaign is associated with a budget and one or more objectives, such as a number of impressions of advertisements from ad requests in the ad campaign to online system users. Any suitable parameters may be associated with the ad campaign in various embodiments, however.

Online system 240 identifies 304 impression opportunities for presenting advertisements from ad requests in the ad campaign to various users. In some embodiments, online system 240 identifies 304 the number of impression opportunities based on the budget and the number of impressions of advertisements associated with the ad campaign. A duration during which advertisements from ad requests in ad campaign may also be used when identifying 304 impression opportunities for the ad campaign. In various embodiments, online system 240 identifies 304 a number of impression opportunities equaling a number of impressions of advertisements associated with the ad campaign. Additionally, online system 240 may account for targeting criteria associated with the ad campaign and a number of online system users having characteristics satisfying the targeting criteria

From the identified number of impression opportunities, online system 240 identifies 306 a control set of impression opportunities. In various embodiments, online system 240 maintains information specifying a percentage of the identified number of impression opportunities to identify 306 as the control set. For example, online system 240 identifies 306 90% to 95% of the identified impression opportunities as the control set. Online system 240 identifies 308 the remaining impression opportunities as a test set of impression opportunities. In the preceding example, online system 240 identifies 308 the remaining 5% to 10% of the identified impression opportunities as the test set. In various embodiments, a user providing the ad campaign to online system 240 specifies a percentage of, or a number of, impression opportunities to identify 308 as the test set, and online system 240 identifies 306 the remaining impression opportunities as the control set. Alternatively, the user providing the ad campaign to online system 240 specifies a percentage of, or a number of, impression opportunities to identify 306 as the control set, and online system 240 identifies 308 the remaining impression opportunities as the test set.

Online system 240 selects 310 a subset of the test set of impression opportunities for which one or more parameters of the ad campaign are modified and used when selecting ad requests for the impression opportunities in the subset of the test set. For example, online system 240 increases a budget of the ad campaign or increases bid amounts of ad requests in the ad campaign relative to the bid amounts or the budget associated with the ad campaign when selecting ad requests for impression opportunities in the subset of the test set of impression opportunities. Online system 240 modifies the one or more parameters for the ad campaign (e.g., increases the ad campaign budget, increases bid amounts of ad requests in the ad campaign) and includes 312 ad requests from the ad campaign along with the modified one or more parameters in selection processes for impression opportunities in the subset of the test set of impression opportunities. For example, ad requests from the ad campaign are associated with an increased budget or with increased bid amounts and included in one or more selection processes selecting ad requests for impressions in the subset of the test set of impression opportunities.

Ad requests from the ad campaign are also included 314 in one or more selection processes selecting ad requests for impression opportunities in the control set of impression opportunities. For impression opportunities in the control set, parameters of the ad campaign are not modified, so the selection processes for impression opportunities in the control set use the parameters associated with the ad campaign when it was received 302 by online system 204. In various embodiments, the budget for the ad campaign or bid amounts for ad requests in the ad campaign received with the ad campaign are included in the selection processes for the impression opportunities in the control set along with ad requests from the ad campaign.

Modifying parameters of the ad campaign for selection processes selecting ad requests for impression opportunities in the subset of the test set may increase likelihoods of ad requests from the ad campaign being selected for the impression opportunities in the subset of the test set. For example, increasing a budget of the ad campaign or increasing bid amounts for ad requests in the ad campaign increases likelihoods of the ad requests from the ad campaign being selected for impression opportunities in the subset of the test set. Additionally, increasing bid amounts for ad requests in the ad campaign or increasing the budget for the ad campaign for impression opportunities in the subset of the test set may increase an average amount of compensation received by online system 240 for presenting advertisements (i.e., a “per-ad spend”). To mitigate the increased likelihood of ad requests from the ad campaign being selected for presentation via impression opportunities in the subset of the test set, online system 240 withholds ad requests from the ad campaign from selection processes for a number of impression opportunities for which ad requests from the ad campaign would otherwise be eligible.

To withhold ad requests from the ad campaign from selection processes for certain impression opportunities for which ad requests from the ad campaign are eligible, online system 240 determines 316 an average amount received by online system 240 from users associated with ad requests selected for presentation via impression opportunities in the control set (also referred to herein as an “average control amount”). For example, the average control amount is an amount received by online system 240 from presentation of ad requests via impression opportunities in the control set divided by the number of impression opportunities in the control set. Based on the average control amount, online system 240 determines 318 an additional subset of the test set of impression opportunities. Online system 240 withholds ad requests from the ad campaign from selection processes for ad impressions in the additional subset of the test subset. This offsets the increased likelihood of ad requests from the ad campaign being selected for impression opportunities in the subset of the test set by preventing selection of ad requests for impression opportunities in the additional subset of the test set. Additionally, ad requests for impression opportunities in the additional subset of the test set having lower bid amounts may be selected, mitigating increases in per-ad spend from modified parameters (e.g., increased bid amounts) for ad requests from the ad campaign selected for impression opportunities in the subset of the test set. Accordingly, online system 140 determines 318 the additional subset of the test set so an average amount of compensation received by online system 240 for presenting advertisements via impression opportunities in the control set is within a threshold value of an average amount of compensation received by online system 240 for presenting advertisements via impression opportunities in the subset of the test set and via impression opportunities in the additional subset of the test set. For example, online system 240 determines 318 the additional subset of the test set so a ratio of an amount received by 240 online system for presentation of advertisements via impression opportunities in the subset of the test set to a combined number of impressions opportunities in the subset of the test set and in the additional subset of the test set equals the average control amount received the online system 240.

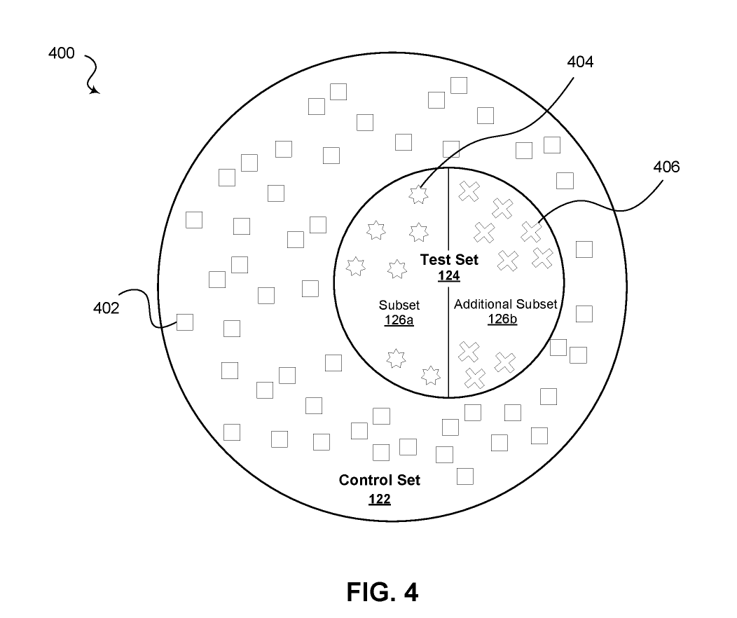

FIG. 4 is a conceptual diagram of an example set 400 of impression opportunities for presenting advertisements from an ad campaign. Set 400 of impression opportunities includes impression opportunities 402, 404, and 406. As further described above in conjunction with FIGS. 1-3, online system 240 divides set 400 of impression opportunities into control set 122 and test set 124, which each include certain numbers or percentages of impression opportunities from set 400 of impression opportunities. In various embodiments, control set 122 is larger than test set 124. For example, control set 122 includes 90% to 95% of impression opportunities in set 400 of impression opportunities, while test set includes 5% to 10% of impression opportunities in the 400 of impression opportunities. As further described above in conjunction with FIGS. 1-3, parameters for the ad campaign are not modified for selection processes selecting advertisements for presentation via impression opportunities in control set 122; for example, bid amounts for ad requests in the ad campaign or a budget for the ad campaign based on parameters of the ad campaign are used by online system 240 when selecting advertisements for impression opportunities in control set 122. Hence, online system 240 uses a budget or bid amounts specified by parameters of the ad campaign when determining whether to present an advertisement from the ad campaign via impression opportunity 402.

However, one or more parameters of the ad campaign are modified for selection processes selecting advertisements are modified for selection process selecting advertisements for impression opportunities in subset 126a of test set 124. For example, online system increases a budget for the ad campaign or increases bid amounts of one or more ad requests in ad campaign when determining whether to select an advertisement from the ad campaign via impression opportunity 404. Online system 240 subsidizes the modification to the parameters of the ad campaign; for example, online system 240 subsidizes increases to bid amounts of ad requests in the ad campaign or an increase to the budget of the ad campaign. In some embodiments, online system 240 increases a bid amount or the budget by a specific adjustment value for each impression opportunity in the subset 126a of the test set 125. Alternatively, online system 240 scales a bid amount specified for an ad request in the ad campaign or the budget specified for the ad campaign by a factor. An increase to a bid amount of an ad request in the ad campaign or to the budget of the ad campaign may be based on the bid amount or the budget specified by parameters of the ad campaign or may be an amount independent of the bid amount or the budget specified by parameters of the ad campaign. For example, a bid amount may be increased by adding a specific value to a bid amount determined from parameters associated with the ad campaign or may be increased by replacing the bid amount determined from parameters associated with the ad campaign with a specific bid amount.

As described above in conjunction with FIGS. 1-3, modifying one or more parameters of the ad campaign for selection processes for impression opportunities in test set 124 increases a likelihood of advertisements from ad requests in the ad campaign being presented via impression opportunities in the test set 125, and may also increase an average amount of compensation received by online system 240 per presentation of an advertisement. To offset the increased likelihood of selecting ad requests from the ad campaign for impression opportunities in test set 125 and also mitigate increasing the average amount of compensation received by online system 240 per presentation of an advertisement, online system 240 withholds ad requests from ad campaign from selection processes for impression opportunities in additional subset 126b. Withholding ad requests from the ad campaign from being selected for impression opportunities in additional subset 126b of test set 124 allows selection of ad requests from other ad campaigns for impression opportunities in additional subset 126 and also increases likelihoods of ad requests having lower bid amounts being selected for impression opportunities in additional subset 126b of test set 124, which reduces the average amount of compensation received by online system 240 per presentation of an advertisement, online system 240. Hence, online system 240 selects an ad request for impression opportunity 406 in additional subset 126b of test set 124 from ad campaigns other than the ad campaign.

Online system 240 determines a number of impression opportunities in additional subset 126b of test set 124 so a ratio of an amount of compensation received by the online system for presentation of ads selected for presentation to users of online system 240 via impression opportunities in subset 126a of test set 124 to a combined number of impression opportunities in subset 126a of test set 124 and impression opportunities in additional subset 126b equals, or is within a threshold amount of, a ratio of an amount of compensation received by online system 240 for presentation of ads selected for presentation to users of online system 240 via impression opportunities in control set 122 to a number of impression opportunities in control set 122 (i.e., the “average control amount.

For example, online system 240 determines a number of impression opportunities in additional subset 126b of test set 124, from which ad requests from the ad campaign are withheld from selection processes, so an average amount of compensation received by online system 240 for impression opportunities in test subset 126a of the test set 124, for which one or more parameters of the ad campaign are modified, equals the average amount of compensation received by online system 240 for impression opportunities in control set 122. In this example, the average amount of compensation received by online system 240 for impression opportunities in test subset 126a of the test set 124 is the amount of compensation received by online system 240 for impression opportunities in subset 126a of the test sent 124 divided by a total number of impression opportunities in subset 126a of test set 124 and in subset 126a of test set 124. Accordingly, advertisements from the ad campaign are not selected for presentation in a disproportionate number of impression opportunities in set 400 of impression opportunities while modification to one or more parameters of the ad campaign is analyzed by online system 240.

In some embodiments, online system 240 determines a number of impression opportunities from which ad requests from the ad campaign are withheld from selection processes (i.e., the number of impression opportunities in additional subset 126b of test set 124) to withhold from presentation in real-time, or in near real-time, to balance the ratio of the amount of compensation received by online system 240 for presentation of ads selected for presentation to users of online system 240 via impression opportunities in subset 126a of test set 124 to a combined number of impression opportunities in subset 126a of test set 124 and impression opportunities in additional subset 126b with the ratio of an amount of compensation received by online system 240 for presentation of ads selected for presentation to users of online system 240 via impression opportunities in control set 122 to the number of impression opportunities in control set 122. For example, as ad requests are selected for presentation via impression opportunities in subset 126a of test set 124, online system 240 modifies a number of impression opportunities in additional subset 126a based on the amount of compensation received by online system 240 for the impression opportunities in subset 126a of test set 124 in real-time to offset an increase the ratio of the amount of compensation received by online system 240 for presentation of ads selected for presentation to users of online system 240 via impression opportunities in subset 126a of test set 124 to a combined number of impression opportunities in subset 126a of test set 124 and impression opportunities in additional subset 126b with the ratio of an amount of compensation received by online system 240 for presentation of ads selected for presentation to users of online system 240 via impression opportunities in control set 122 to the number of impression opportunities in control set 122 Alternatively, the relative size of subset 126a of test set 124 and additional subset 126b of test set 125 is estimated or determined by online system 240 based on historical data for the ad campaign or historical data for other ad campaigns in the online system 240. Other methods for identifying and segmenting the impression opportunities may also be used in other embodiments.

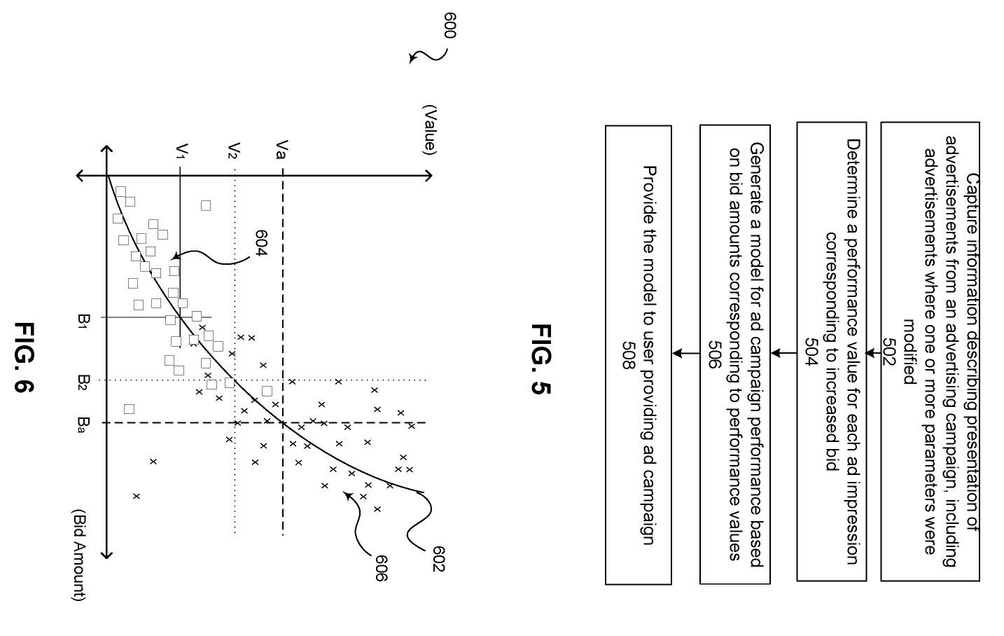

FIG. 5 is a flowchart illustrating one embodiment of a process for describing performance of an advertising campaign when one or more parameters of the advertising campaign are modified. As rates for presenting advertisements via online system 240 are often well established, users may be reluctant to modify parameters of advertising campaigns (“ad campaigns) by increasing budgets for ad campaigns, by increasing bid amounts for ad requests in ad campaigns, or by modifying other parameters of ad campaigns. As described above in conjunction with FIGS. 1-4, online system 240 may modify one or more parameters of an ad campaign and capture information describing performance of the ad campaign with the modified one or more parameters. Online system 240 may provide the information describing performance of the ad campaign with the one or more modified parameters to a user associated with the ad campaign, providing the user with information about how modifying parameters may affect performance of the ad campaign affects performance of the ad campaign.

Online system 240 captures 502 information describing presentation of advertisements from ad requests in an ad campaign for which one or more parameters were modified for selection processes for certain impression opportunities. As described above in conjunction with FIGS. 3 and 4, bid amounts of ad requests in the ad campaign or a budget of the ad campaign may be increased for selection processes selecting ad requests for various impression opportunities, while the bid amounts and budget remain unchanged from what was specified in the ad campaign for selection processes selecting ad requests for other impression opportunities. As advertisements from the ad campaign are presented, online system 240 captures 502 information describing presentation of the advertisements. In various embodiments, online system 240 associates information with an ad request including a presented advertisement that identifies a bid amount for the ad request and that may identify any other suitable parameters of the ad request or of the ad campaign (e.g., budget, bid amounts). Information describing interactions by users with advertisements from the ad campaign presented to the user is received by online system 240, which determines 504 performance metrics for each presented advertisement from the ad campaign. A performance value may be a conversion ratio of a number of a specific interaction with the advertisement to a number of impressions of the advertisement, may be a number of a specific interaction with the advertisement, may be a number of impressions of the advertisement, or may be any other suitable value. Example interactions with an advertisement include: accessing the advertisement, purchasing a product or service associated with the advertisement, downloading an application associated with the advertisement, indicating a preference for an object associated with the advertisement or any other suitable interaction.

In various embodiments, online system 240 generates 506 a model for ad campaign performance based on bid amounts of advertisements presented from selected ad requests and performance values for the presented advertisements. For example, the model associates different performance values with different bid amounts. As the determined performance values include performance of advertisements from ad requests having bid amounts increased relative to the bid amounts specified by the ad campaign, the model identifies performance values for a larger range of bid amounts than specified by the ad campaign. FIG. 6 is an example graph 600 showing a relationship between bid amounts and performance values for an ad campaign. Graph 600 shows performance values for ad requests from the ad campaign having bid amounts 604 specified by the ad campaign and performance values for ad requests from the ad campaign having bid amounts 606 that were increased relative to bid amounts specified by the ad campaign. Based on performance values for ad requests having different bid amounts, online system 240 generates model 602 correlating performance values with bid amounts. Model 602 may be generated by any suitable statistical analysis of pairings of performance values with bid amounts in different embodiments. For example, model 602 identifies performance value V₁ for bid amount B₁ and similarly identifies performance value V₂ for bid amount B₂. In the example of FIG. 6, few ad requests in the ad campaign have bid amounts greater than B₂. Hence, there is limited data for determining performance values for bid amounts greater than B₂ in the ad campaign. Online system 240 subsidizes increased bid amounts bid amounts greater than B₂ as described above in conjunction with FIGS. 1-5 to provide performance values for a greater range of bid amounts. Online system 240 provides 508 model 602 to a user associated with the ad campaign, allowing the user to evaluate potential performance of the ad campaign over a broader range of bid amounts, which may provide the user with an incentive to provide larger bid amounts for the ad campaign based on performance values determined by the model. While FIG. 6 shows an example of a model 602 associating performance values with bid amounts, in other embodiments, a model associates performance values with amounts provided to the online system 240 for presenting an advertisement from an ad request.

### Summary

The foregoing description of embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of embodiments is intended to be illustrative, but not limiting, of the scope of the patent rights, which is set forth in the following claims.

What is claimed is:

1. A method comprising:
receiving, by an online system, an advertising campaign (“ad campaign”) including one or more advertisement requests (“ad requests”) each including an advertisement and having a bid amount, the ad campaign including a budget and a desired number of impressions of advertisements (“ads”) from ad requests in the ad campaign;
identifying a plurality of impression opportunities to present one or more ads from ad requests in the ad campaign to users of the online system based at least in part on the budget and the desired number of impressions of advertisements;
identifying a control set of impression opportunities from the plurality of impression opportunities, bid amounts for ad requests from the ad campaign for impression opportunities in the control set determined based at least in part on the budget and the desired number of impressions of ads included in the ad campaign;
identifying a test set of impression opportunities from the plurality of impression opportunities;
selecting a subset of the test set of impression opportunities, bid amounts for ad requests from the ad campaign in the subset of the test set increased relative to bid amounts determined at least in part on the budget and the desired number of impressions of ads included in the ad campaign;
including ad requests from the ad campaign with the increased bid amounts in one or more selection processes selecting advertisements for presentation to users of the online system via impression opportunities in the subset of the test set of impression opportunities;
including ad requests from the ad campaign with bid amounts determined based at least in part on the budget and the desired number of impressions of ads included in the ad campaign in one or more selection processes selecting advertisements for presentation to users of the online system via impression opportunities in the control set;
determining an average control amount received by the online system for presentation of advertisements selected by the one or more selection processes for presentation to users of the online system via impression opportunities in the control set; and
determining an additional subset of the test set of impression opportunities from which ad requests from the ad campaign are withheld from one or more selection processes, the additional subset of the test set of impression opportunities including a number of impression opportunities so a ratio of an amount received by the online system for presentation of advertisements via impression opportunities in the subset of the test set to a number of impression opportunities in the subset and in the additional subset is within a threshold amount of the average control amount received by the online system.

2. The method of claim 1, further comprising:
determining a performance value for each ad request from the ad campaign selected for presentation and a bid amount for each ad request from the ad campaign selected for presentation, the performance value for an ad request based at least in part on interaction with an advertisement from the ad request by a user presented with the advertisement; and
determining a relationship between bid amounts and determined performance values.

3. The method of claim 1, wherein the additional subset of the test set of impression opportunities includes a number of impression opportunities so the ratio of an amount received by the online system for presentation of ads via impression opportunities in the subset of the test set to a number of impression opportunities in the subset and in the additional subset equals the average control amount received by the online system.

4. The method of claim 1, wherein bid amounts for ad requests from the ad campaign in the subset of the test set increased to bid amounts determined at least in part on the budget and the desired number of impressions of ads included in the ad campaign is subsidized by the online system.

5. The method of claim 1, wherein bid amounts for ad requests from the ad campaign in the subset of the test set are increased by adding a specific value to bid amounts determined at least in part on the budget and the desired number of impressions of ads included in the ad campaign.

6. The method of claim 1, wherein bid amounts for ad requests from the ad campaign in the subset of the test set are increased by replacing bid amounts determined at least in part on the budget and the desired number of impressions of ads included in the ad campaign with a specific bid amount.

7. The method of claim 1, wherein identifying the control set of impression opportunities from the plurality of impression opportunities comprises:
identifying a specified percentage of the plurality of impression opportunities as the control set.

7. The method of claim 6, wherein identifying the test set of impression opportunities from the plurality of impression opportunities comprises:
identifying impression opportunities from the plurality of impression opportunities not in the control set as the test set.

8. The method of claim 6, wherein the specified percentage is between 90% and 95%.

9. A method comprising:
receiving, by an online system, an advertising campaign (“ad campaign”) including one or more advertisement requests (“ad requests”) each including an advertisement and having a bid amount, the ad campaign associated with one or more parameters;
identifying a plurality of impression opportunities to present one or more ads from ad requests in the ad campaign to users of the online system;
identifying a control set of impression opportunities from the plurality of impression opportunities;
identifying a test set of impression opportunities from the plurality of impression opportunities;
selecting a subset of the test set of impression opportunities, one or more parameters associated with the ad campaign modified for impression opportunities in the subset of the test set;
including ad requests from the ad campaign using the modified one or more parameters associated with the ad campaign in one or more selection processes selecting advertisements for presentation to users of the online system via impression opportunities in the subset of the test set of impression opportunities;
including ad requests from the ad campaign using the one or more parameters associated with the ad campaign in one or more selection processes selecting advertisements for presentation to users of the online system via impression opportunities in the control set;
determining an average control amount received by the online system for presentation of advertisements selected by the one or more selection processes for presentation to users of the online system via impression opportunities in the control set; and
determining an additional subset of the test set of impression opportunities from which ad requests from the ad campaign are withheld from one or more selection processes, the additional subset of the test set of impression opportunities including a number of impression opportunities so that a ratio of an amount received by the online system for presentation of advertisements via impression opportunities in the subset of the test set to a number of impression opportunities in the subset and in the additional subset is within a threshold amount of the average control amount received by the online system.

10. The method of claim 9, further comprising:
determining a performance value for each ad request from the ad campaign selected for presentation and one or more parameters of the ad campaign for each ad request from the ad campaign selected for presentation, the performance value for an ad request based at least in part on interaction with an advertisement from the ad request by a user presented with the advertisement; and
determining a relationship between one or more parameters associated with the ad campaign and the determined performance values.

11. The method of claim 9, wherein the additional subset of the test set of impression opportunities includes a number of impression opportunities so the ratio of an amount received by the online system for presentation of ads via impression opportunities in the subset of the test set to a number of impression opportunities in the subset and in the additional subset equals the average control amount received by the online system

12. The method of claim 9, wherein a parameter of the ad campaign comprises a budget.

13. The method of claim 12, wherein using the modified one or more parameters associated with the ad campaign in one or more selection processes selecting advertisements for presentation to users of the online system via impression opportunities in the subset of the test set of impression opportunities comprises:
using an increased budget for the ad campaign in one or more selection processes selecting advertisements for presentation to users of the online system via impression opportunities in the subset of the test set of impression opportunities comprises.

14. The method of claim 9, wherein identifying the control set of impression opportunities from the plurality of impression opportunities comprises:
identifying a specified percentage of the plurality of impression opportunities as the control set.

15. The method of claim 14, wherein identifying the test set of impression opportunities from the plurality of impression opportunities comprises:
identifying impression opportunities from the plurality of impression opportunities not in the control set as the test set.

16. A computer program product comprising a computer readable storage medium having instructions encoded thereon that, when executed by a processor, cause the processor to:
receive, by an online system, an advertising campaign (“ad campaign”) including one or more advertisement requests (“ad requests”) each including an advertisement and having a bid amount, the ad campaign including a budget and a desired number of impressions of advertisements (“ads”) from ad requests in the ad campaign;
identify a plurality of impression opportunities to present one or more ads from ad requests in the ad campaign to users of the online system based at least in part on the budget and the desired number of impressions of advertisements;
identify a control set of impression opportunities from the plurality of impression opportunities, bid amounts for ad requests from the ad campaign for impression opportunities in the control set determined based at least in part on the budget and the desired number of impressions of ads included in the ad campaign;
identify a test set of impression opportunities from the plurality of impression opportunities;
select a subset of the test set of impression opportunities, bid amounts for ad requests from the ad campaign in the subset of the test set increased relative to bid amounts determined at least in part on the budget and the desired number of impressions of ads included in the ad campaign;
include ad requests from the ad campaign with the increased bid amounts in one or more selection processes selecting advertisements for presentation to users of the online system via impression opportunities in the subset of the test set of impression opportunities;
include ad requests from the ad campaign with bid amounts determined based at least in part on the budget and the desired number of impressions of ads included in the ad campaign in one or more selection processes selecting advertisements for presentation to users of the online system via impression opportunities in the control set;
determine an average control amount received by the online system for presentation of advertisements selected by the one or more selection processes for presentation to users of the online system via impression opportunities in the control set; and
determine an additional subset of the test set of impression opportunities from which ad requests from the ad campaign are withheld from one or more selection processes, the additional subset of the test set of impression opportunities including a number of impression opportunities so a ratio of an amount received by the online system for presentation of advertisements via impression opportunities in the subset of the test set to a number of impression opportunities in the subset and in the additional subset is within a threshold amount of the average control amount received by the online system.

17. The computer program product of claim 16, wherein the computer readable storage medium further has instructions encoded thereon that, when executed by the processor, cause the processor to:
determine a performance value for each ad request from the ad campaign selected for presentation and a bid amount for each ad request from the ad campaign selected for presentation, the performance value for an ad request based at least in part on interaction with an advertisement from the ad request by a user presented with the advertisement; and
determine a relationship between bid amounts and determined performance values.

18. The computer program product of claim 16, wherein the additional subset of the test set of impression opportunities includes a number of impression opportunities so the ratio of an amount received by the online system for presentation of ads via impression opportunities in the subset of the test set to a number of impression opportunities in the subset and in the additional subset equals the average control amount received by the online system.

19. The computer program product of claim 16, wherein bid amounts for ad requests from the ad campaign in the subset of the test set increased to bid amounts determined at least in part on the budget and the desired number of impressions of ads included in the ad campaign is subsidized by the online system.

20. The computer program product of claim 16, wherein identify the control set of impression opportunities from the plurality of impression opportunities comprises:
identify a specified percentage of the plurality of impression opportunities as the control set.
